(19) United States
(12) Patent Application Publication
(10) Pub. No.: US 2012/0089468 A1
(43) Pub. Date: Apr. 12, 2012

(54) Lottery Ticket Purchase Apparatus And Method

(75) Inventor: Paul F. Guziel, Roswell, GA (US)

(73) Assignee: Alchemy3, LLC., Alpharetta, GA (US)

(21) Appl. No.: 13/269,593

(22) Filed: Oct. 8, 2011

Related U.S. Application Data
(60) Provisional application No. 61/391,218, filed on Oct. 8, 2010.

(51) Int. Cl. G06Q 30/06

(52) U.S. Cl. 705/16

(57) ABSTRACT

A mobile communication device configured with an application and short-range wireless hardware to create a temporary connection with a lottery point-of sale ticket system in order for a player to purchase a lottery game ticket at a remote, but proximate location local to an authorized lottery retailer. A method by which a lottery ticket may be purchased is disclosed. The apparatus and method readily applies to remote purchase of goods or services while a buyer is local to a store having a terminal offering goods or services for sale.

The present application claims benefit of U.S. Provisional Patent Application Ser. No. 61/391,218, filed Oct. 8, 2010.

### TECHNICAL FIELD

The present invention relates to apparatus and methods by which buyers purchase goods or services from vendors, such as players purchasing lottery game tickets. More particularly, the present invention relates to methods and apparatus for remote buyers to complete purchase transactions using buyer operated mobile communications devices that interact with a local sales terminal offering goods or services for sale. More particularly, in an exemplary embodiment, the present invention relates to methods and apparatus for completing lottery ticket purchase transactions using player operated mobile communication devices that interact with lottery ticket terminals to thereby permit remote but local purchase transactions.

### BACKGROUND OF THE INVENTION

Since the mid-1980s introduction of ‘Pay-at-the-Pump’ self-service payment methods at filling stations, lottery organizations have experienced increasing difficulty in getting prospective consumers or players into filling station establishments for consumer exposure to lottery ticket sales opportunity. The impulse lottery ticket purchase has been removed by this convenience of payment for fuel by a driver located relatively remote from the cashier in the filling station but nevertheless local to the particular filling station. Thus, the customer is local to the filling station but within that context is remote from the cashier. In response, lottery organizations have used non-traditional advertising methods (particularly, display advertising and signage placed at or on fuel pump stands) in an effort to reverse the decline in potential sales exposure. Similar difficulties are present at establishments that include lottery ticket sales and also provide for non-in-store transactions, such as drive-through pharmacies, exterior vending devices for DVD sales or rentals which devices are increasing located at convenience stores and other retail establishments.

Generally, there is sufficient time involved in fueling a vehicle for a customer to observe and act on the display advertising and signage for lottery games. From the time a driver begins filling a fuel tank, there is typically a 3 to 5 minute period before the driver completes the transaction. While that would be sufficient time for the driver to enter the store and purchase a lottery ticket, many often do not want to leave the vehicle unattended while the pump is delivery fuel. Many pumps also indicate that the driver must remain near the pump during fueling operation. In addition, leaving the pump to enter the store for purchases defeats the convenience of the driver being able to pay for fuel at the pump.

Existing United States legislation prohibits the purchase of lottery tickets over telephone connections, including the Internet. Lotteries in the United States are required to sell tickets through authorized lottery retail direct sales locations only. Every lottery ticket sale is credited to a retail location which hosts the ticket terminal.

The retail sales trade generally has, and is, testing and developing alternative outlets and systems for sales of goods and services. For example, shopping centers and malls are increasingly placing specialty kiosks in the common customer walk-way halls between store fronts. Kisoks generally have limited inventory and focus on providing a variety of goods that are within a narrow category, for example, scarves, sunglasses, or watches and clocks.

In addition to lottery tickets, non-lottery products and non-lottery ticket products may also be purchased at retail sales counters. These non-lottery ticket products include product or service gift cards or coupons having exchangeable or redeemable value.

Technology communication developments have facilitated remote but local activities of computerized devices and of mobile communication devices. For example, BLUETOOTH and 802.11 WIFI signals operating on 2.4 GHz frequency (short wavelength radio transmissions) can have a range of up to 300 feet.

Accordingly, there is a need in the art for apparatus and methods that facilitate purchase of goods or services from retailers. It is to such that the present invention is directed.

### BRIEF SUMMARY OF THE INVENTION

The present invention meets the need in the art by providing a method for completing a lottery ticket purchase transaction local to a lottery ticket retailer location but remote from a lottery ticket cashier, comprising:

establishing a temporary connection between a mobile communications device of a player and a lottery point-of-sale terminal through short range wireless communications protocol;

displaying on a display screen of the mobile communications device at least one indicia of an available lottery game, each lottery game available having a discrete indicia;

selecting a lottery game for which a game ticket is to be purchased;

accessing a payment transfer system to transfer funds from an account of the player to the account of the lottery provider to purchase the game ticket; and

transferiing to the mobile communications device an electronic lottery game ticket.

In another aspect, the present invention provides an apparatus for completing a lottery ticket purchase transaction local to a lottery ticket retailer location but remote from a lottery ticket cashier, comprising a short range wireless transceiver connected to a lottery point-of-sale terminal for establishing a temporary connection with a mobile communications device of a player through a wireless communications protocol. The mobile communications device is configured to display at least one indicia of an available lottery game, each lottery game available having a discrete indicia, and includes selection means for selecting a lottery game for which a game ticket is to be purchased. An access link to a payment transfer system communicates with an account of the player and an account of the lottery provider for transferring funds from the account of the player to the account of the lottery provider to pay for the game ticket purchased by the player. An electronic lottery game ticket is transferred from the point-of-sale terminal to the mobile communications device.

In another aspect, the present invention provides a method for completing a purchase transaction local to a retailer location but remote from a cashier therefor, comprising the steps of:

(a) establishing a temporary connection between a mobile communications device of a buyer and a point-of-sale terminal through a short range wireless communications protocol;

(b) displaying on a display screen of the mobile communications device at least one indicia of an available product or service offered for selective purchase through the terminal by the buyer, each available product or service having a discrete indicia;

(c) selecting one of the available products or services which is to be purchased;

(d) accessing a payment transfer system to transfer funds from an account of the buyer to the account of the seller to purchase the selected one of available products or services; and

(e) transferring to the mobile communications device an electronic ticket representative of the purchase of the selected one of the available products or services.

In another aspect, the present invention provides an apparatus for completing a purchase transaction local to a retailer location but remote from a cashier therefor, comprising a short range wireless transceiver connected to a point-of-sale terminal for establishing a temporary connection with a mobile communications device of a buyer through a wireless communications protocol. The mobile communications device is configured to display at least one indicia of an available product or service offered for sale by the terminal, each available product or service having a discrete indicia, with selection means for selecting one of the available product or service which is to be purchased. An access link connects to a payment transfer system that communicates with an account of the buyer and an account of the seller for transferring funds from the account of the buyer to the account of the seller to pay for the selected one of the products or services purchased by the buyer. An electronic ticket representative of the purchase of the selected one of the products or services transfers from the point-of-sale terminal to the mobile communications device.

Objects, features and advantages of the present invention will be apparent upon reading the following detailed description in conjunction with the drawings and the appended claims.

### BRIEF DESCRIPTION OF THE DRAWINGS

FIG. 1 illustrates a schematic view of a lottery retailer fuel filling station showing placement of a lottery system terminal in the station and a relative indication of distance to the fuel pumps.

FIG. 2A illustrates a mobile communications device displaying available games of the lottery provider for selection and play through the lottery system terminal.

FIG. 2B illustrates a mobile communications device displaying ticket purchase selection buttons for a selected random draw game.

FIG. 2C illustrates a mobile communications device displaying a series of game numbers for selection by the player for a game ticket purchase.

FIG. 2D illustrates a mobile communications device displaying a second of the series of game numbers for selection by the player for a game ticket purchase.

FIG. 3 illustrates a mobile communications device displaying a link to a commercial account and transaction payment service for authorizing transfer of funds from an account of the player to the account of the lottery game provider.

FIG. 4 illustrates a mobile communications device displaying an electronic random draw game ticket communicated by the lottery sales terminal to the mobile communications device after purchase by the player.

FIG. 5 illustrates a schematic view of a portion of a shopping mall with a retail store having a product or services sales terminal communicating with a remote mobile communications device of a buyer local to the retail store for sales and purchase of products or services offered by the retail store.

### DETAILED DESCRIPTION

The term “remote” as used in the present application is defined to mean “spaced-apart from” or “not adjacent”.

The term “local” as used in the present application is defined to mean “within a proximity of” or “close by” or “near”.

For example, fuel pumps at filling stations often are positioned in stands that are spaced-apart from a building that houses a cashier. The fuel pumps are remote, or spaced-apart from the cashier but the fuel pumps are local or close by the filling station itself.

As another example, a products display area in a retail store often is positioned spaced-apart from a check-out or cashier stand for the store. The product display area is remote or spaced-apart from the cashier stand but is local to the store premises itself.

The present invention is directed to an apparatus and method for creating a remote short-range communications connection between a mobile communications device of a buyer and a goods or services sales terminal in order to complete a purchase transaction while the buyer is within a local range of the terminal. In a particular exemplary embodiment, the apparatus and method creates a remote short-range communications connection between a mobile communications device of a player of lottery games and a lottery terminal in order to complete a lottery ticket purchase transaction while the player is within a local range of the terminal. The transaction information is stored on the user device and within the lottery system database. This permits a subsequent request and printing of a transaction receipt and ticket if necessary to claim a win. The monetary transaction in payment the game ticket is made using a mobile communications device and an access link to a payment system that maintains respective money accounts for the player and for the lottery game provider. The player in purchasing the game ticket authorizes the payment system to effect transfer of funds from the player's account to the account of the lottery game provider.

The present invention employs the BLUETOOTH (WPAN) or 802.11 (WLAN) wireless interface features of a mobile phone to connect to and communicate with an authorized retail lottery system terminal to complete a short-range remote ticket purchase transaction. Other wireless communications systems now know or later developed may gainfully be used.

Generally, the present invention is directed to:
apparatus and method for temporarily connecting an enabled mobile device with a lottery point-of-sale terminal system using short range wireless communications protocol;
apparatus and method by which the mobile communications device uses a mobile software application to generate a unique encrypted key;
apparatus and method by which the encrypted key is used to create a secure connection between the mobile communications device and the lottery system point-of-sale system;
apparatus and method by which the lottery point-of-sale system cause a display of the available game choices on the mobile communications device;
apparatus and method by which the consumer user interface selections are stored and returned back to the lottery point-of-sale system to log the ticket purchase transaction;
apparatus and method by which the monetary transaction effecting payment for the purchase of the game ticket is made using a commercial account and transaction payment service for transferring funds from the player to the lottery game provider;
apparatus and method by which a unique ticket serial number barcode associated with the game ticket purchased by the player in the practice of the present invention is displayable on the display screen of the mobile communication device to create a paperless validation alternative for the retailer in redemption of a wining game ticket.

More particularly, the present invention is directed to apparatus for completing a lottery ticket purchase transaction local to a lottery ticket retailer location but remote from a lottery ticket cashier, comprising a short range wireless transceiver connected to a lottery point-of-sale terminal for establishing a temporary connection with a mobile communications device of a player through a wireless communications protocol. The mobile communications device is configured to display at least one indicia of an available lottery game, each lottery game available having a discrete indicia, and includes selection means for selecting a lottery game for which a game ticket is to be purchased. An access link to a payment transfer system communicates with an account of the player and an account of the lottery provider for transferring funds from the account of the player to the account of the lottery provider to pay for the game ticket purchased by the player. An electronic lottery game ticket is transferred from the point-of-sale terminal to the mobile communications device. The electronic lottery game ticket may be saved as an electronic file, displayed, or communicated, for example, to a printing device for reproducing as a paper copy.

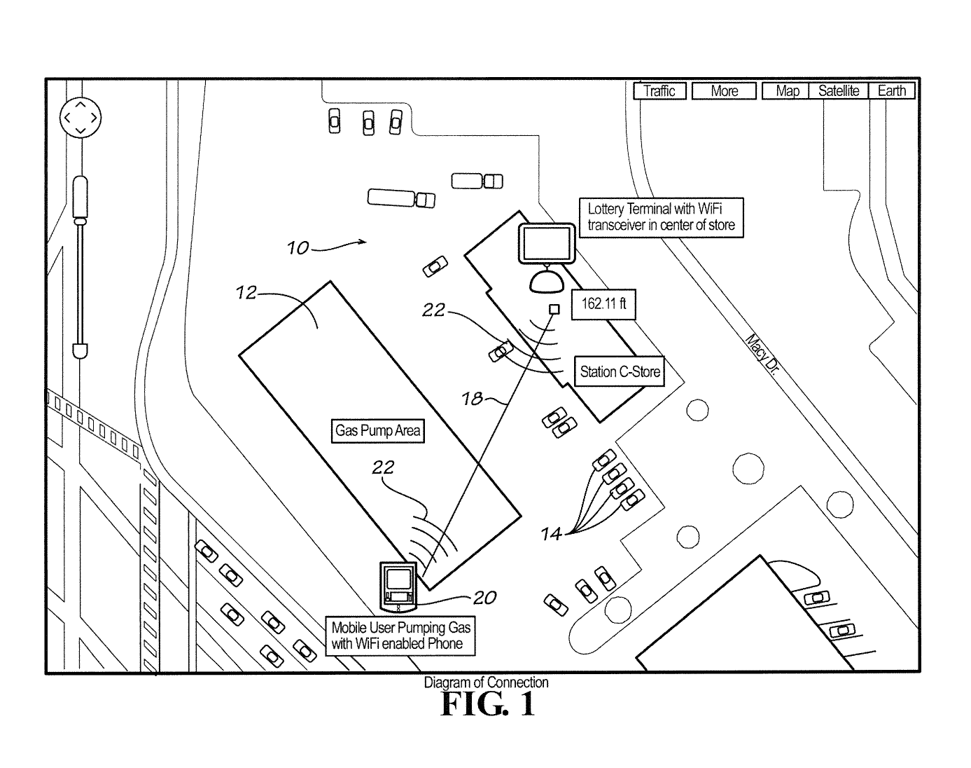

Generally described, FIG. 1 illustrates a schematic diagram of the wireless connection. Particularly, FIG. 1 illustrates a plan view of a standard lottery retailer filling station showing the terminal placement in store and the distance to the furthest pumps.

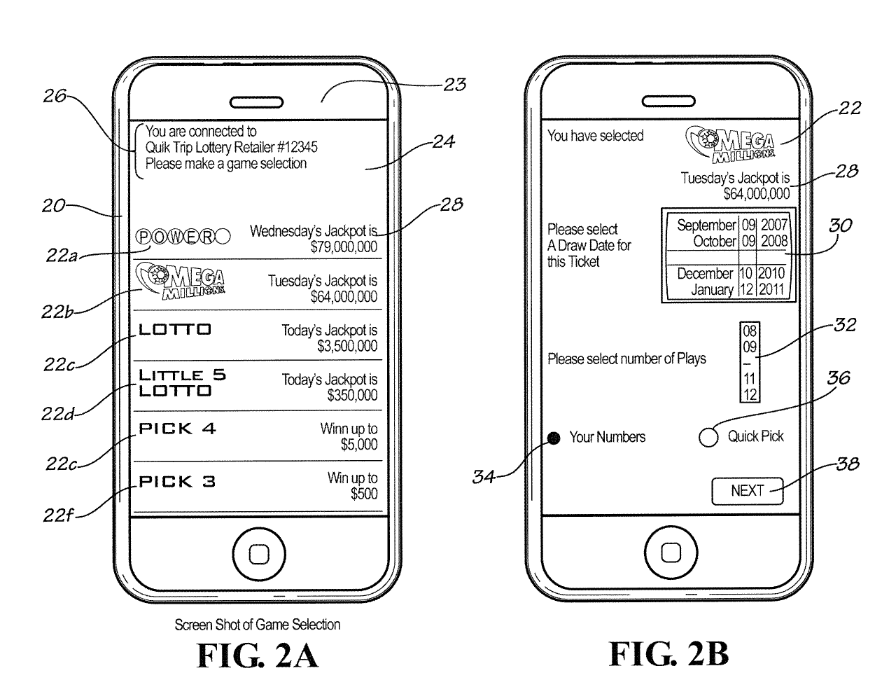

The drawings on sheet FIG. 2 illustrate screen displays of the mobile device during game ticket selection. As discussed below, once the player makes a remote connection from the mobile communications device to the lottery terminal, the display screen presents game selection and ticket selection screens operated by the player to select the game and the game ticket to be purchased.

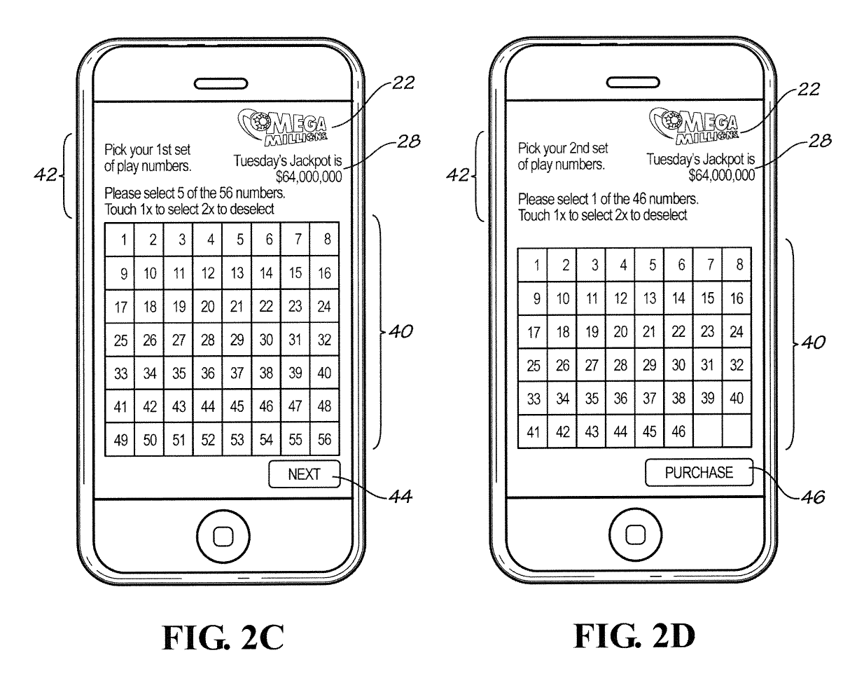

FIG. 3 is an image of a display on the mobile communication device relating to the commercial transaction and payment service effecting the payment transaction for purchase of the game ticket. The display presents a table showing the debit transaction to transfer funds from the account of the player to the lottery account.

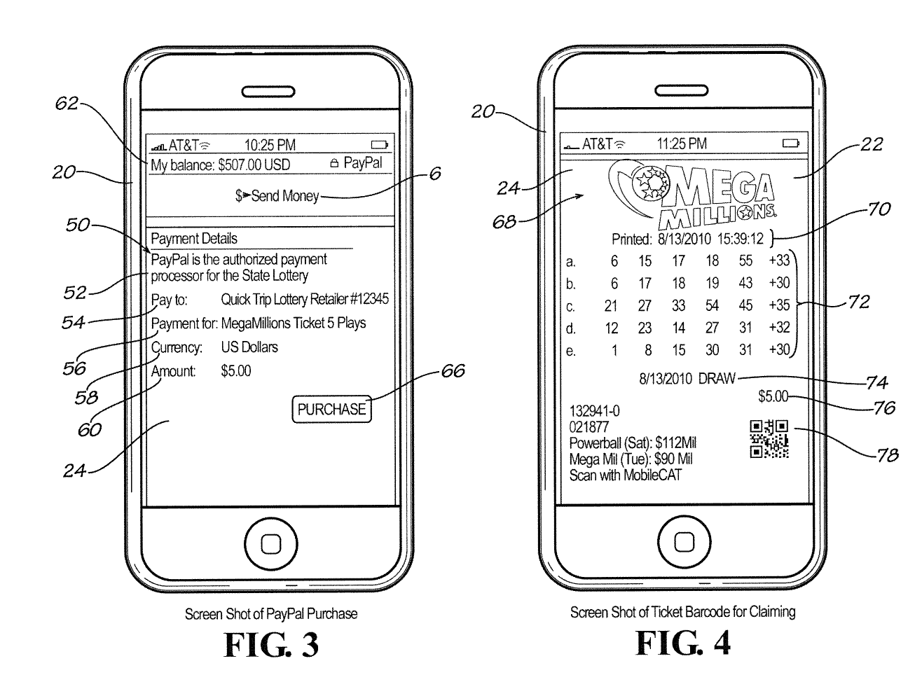

FIG. 4 illustrates a display on the mobile communication device of the electronic game ticket including a ticket barcode for claiming a winning prize. The unique ticket serial number barcode may appear on the mobile device screen for the retailer to use in place of the printed paper ticket to validate a claim.

Beyond cellular communication hardware, mobile smartphones come equipped with additional wireless hardware technologies—BLUETOOTH and 802.11 WIFI transceivers. These can be used to connect the phone wirelessly to peripheral devices such as headsets, speakers and Internet modems connected to routers. The distance between the two devices must be within as specified short range. In addition, Near Field Communication (NFC) devices can be employed for communicating between a player and the lottery ticket terminal. Generally, NFC devices have short-range high frequency wireless communication technology that enables the exchange of data between devices over about a 10 centimeter (around 4 inches) distance.

When a compliant device emits a signal on a given radio frequency, the receiving Smartphone can connect to it in order to send data packets between the two devices.

A lottery ticket system is a closed-network mainframe terminal that records lottery ticket transactions made at authorized retail locations. The games sold on these terminals are referred to as ‘online games’, though they are not connected to or ever interface with the Internet.

The Wire Act of 1961 in the United States prohibits the use of wire communication to assist in placing wagers or betting. The Internet falls under that law as an illegal means of transmitting a wager. Understanding this, the short range WIFI connection to a dedicated device may not violate the Act.

Ticket purchase transactions are sent from the terminal to a lottery secure database. Once a request is sent via a closed network lottery retailer ticket terminal, the ticket record is added to the secure database.

This path ensures that a lottery ticket can only be created by one of these authorized terminals. The terminals are not connected to the Internet as a legislative restriction that prevents account wagering and interstate gambling.

The same lottery ticket terminals are equipped with standard input expansion hardware like USB and Ethernet ports. This allows for a connection to a BLUETOOTH or 802.11 WIFI Wireless Access Point (WAP) receiver/transmitter. Typically, the rough distance between a lottery terminal inside a store and a furthest pump of a conventional filling station is no more than 160-200 feet. This is sufficient local proximity for the driver to make a connection to the lottery terminal with a mobile communications device. Alternatively, or in addition, the lottery ticket terminal and the remote but local fuel pumps are equipped for NFC communications.

With a WAP connected to the lottery terminal, an enabled wireless device within the signal radius of the terminal can make a temporary connection.

The mobile application software that was developed to support this invention will create this connection and complete the transaction. In order to secure the transaction, a connection to the lottery ticket terminal may be made by registered users of the application. While a wireless device can receive multiple signals, the application software in an illustrative embodiment may be required to handshake with the terminal. In this embodiment, a combination of the application software serial number and UDID of the mobile communications device registers with the lottery terminal database to create an encrypted ‘key’ to give the user access privileges to make the purchase. The encrypted key is generated when a player receives from the lottery provider, and installs, a software application on the mobile communications device. The player registers the application and may register player identification information such as name, contact information, account or payment information.

Once a connection is made between the mobile device and the lottery terminal, the application opens the display screen to make the selection. Much like a vending machine, the different game icons appear asking the player to make a game choice. The choices will be limited to the offerings of that specific retailer terminal. Once the player selects a game, he must select a draw date. Once the draw date is selected, the player can make his number selections or click “Quick Pick”. If the player wants to add additional plays to the ticket, the player selects an “Add more tickets” feature. When they are done adding their tickets, the player selects “Complete Purchase” and the transaction is initiated and logged into the lottery system via the terminal.

In addition to being registered to use the application remote connection, the user must also have a valid account accessible by a commercial transaction and payment service. One such service is PAYPAL account services. Other account and transaction processing systems such as credit accounts, subscription accounts, debit card transaction accounts, including balance accounts provided by a commercial accounts and payment provider or lottery vendor providing such services are suitable. The application accesses the transaction and payment service to create a monetary remote transaction between the consumer/player and the lottery ticket retailer. In an illustrative embodiment, the transaction and payment service may use a debit transaction. As a social responsibility, lotteries generally do not allow ticket purchases using credit. The commercial PAYPAL service that registers to a valid savings or checking account makes this service appropriate for completing this transaction. However, an embodiment of the present invention may have a transaction and payment service that uses credit accounts or other accounts as noted above.

Communications between the player using a mobile communications device and the terminal may be made using a mobile software application with an encrypted key to secure the connection, as discussed above. The application then launches the remote transaction purchase screens.

The funds may be transferred through a commercial transaction and payment account connected to a savings or checking account of the consumer. Lotteries generally will not allow ticket purchases to be made with a credit card. However, the present invention is not limited to accessing only cash accounts for payments but readily can access credit accounts, subscription accounts in which a consumer arranges for routine periodic purchases, or other money funds holding and transferring accounts discussed above.

At the point-of-purchase for the mobile ticket transaction, the application makes a connection to the player's account with the commercial transaction and payment service to determine if there are sufficient funds available in the player's account to purchase the ticket. If there are not, the transaction is rejected and the player is alerted that he needs to replenish the account.

If there are sufficient funds, the ticket purchase amount is deducted from the player's account and transmitted electronically to the attached lottery account associated with the commercial transaction and payment service. This transmission is completed using the player's cellular communication data service. Because the lottery terminal is not connected to the world wide web or interne, the lottery terminal cannot make that transmission.

Because the purchase transaction is logged in the lottery mainframe, the lottery provider can reference this transaction to pay the retailer's commission.

The purchase is made and logged with the application and therefore these tickets are automatically logged on the device to return winning results after the draw.

When the ticket purchase transaction is complete, the player is asked if he wants to print a copy of the ticket. Because the player has to return the ticket to an authorized lottery retailer to validate and claim a prize, he may need a hard copy print out. However, the ticket only needs to be printed if a player needs to claim a win. If the ticket doesn't yield any winning combinations, printing is unnecessary. This reduces paper waste and promotes environmental responsibility and efficiency.

To further the efforts of reducing paper waste, if the ticket is a winner, the player can claim the prize using the display on the device. The lottery terminal generates the unique ticket serial number barcode upon purchase of the lottery game ticket. That bar code is included in an electronic game ticket returned to the player. With that barcode displayed on the device LCD display, the retailer may read the screen image with a terminal barcode scanner in order to validate the win status without printing out the ticket.

An exemplary embodiment of the present invention is disclosed with reference to the drawings, in which like parts have like reference numerals. FIG. 1 illustrates a schematic plan view of a lottery retailer fuel filing station 10 and a gas pump area 12 having a plurality of fuel pumps conventionally used for refueling of motor vehicles. It is noted that while the exemplary embodiment illustrates a game ticket vendor in association with a fuel filling station retail establishment, such retail establishment is not limiting but that the present invention is gainfully deployed in connection with game ticket vending at other retail establishments and particularly those establishments that provide a remote but local purchase transaction capability. Further, as discussed below, an alternate embodiment facilitates a remote buyer purchasing products or services from a local sales terminal offering such products or services for sale through communication with the mobile communication device of the buyer.

Various motor vehicles 14 are depicted in the parking area of the filling station 10. The filling station 10 includes a lottery terminal 16 illustrated schematically in an selected area of the filling station 10. Often the lottery terminal is placed with a cashiers office or area of the filling station. A line generally designated 18 depicts a distance between the lottery terminal 16 and thus the distance to a lottery game player having a mobile communication device 20 near the pump area 12 of the filling station 10. Spaced acruate lines generally 22 indicate wireless communication between the mobile communication device 20 and the lottery terminal 16.

FIG. 2A illustrates the mobile communications device 20 after a communications link is established between the mobile communications device 20 and the lottery terminal 16. The mobile communications device 20 displays on a display screen 24 one or more lottery game indicia 22 of games available for play through the lottery terminal 16. The display includes a conformation 23 of the connection to the lottery retailer terminal 16 and instructions to select a game generally 26. In the illustrated embodiment, the display includes potential winning information 28.

FIG. 2B illustrates the mobile communications device 20 displaying game ticket selection buttons for a selected random draw game 22. The display 24 displays an icon or indicia 22 representative of the selected game as well as the potential winnings 28. The display 24 includes a scroll screen 30 for selecting a draw date for the ticket to be purchased. A number of plays selector 32 allows the player to select the number of game tickets to purchase. The display 24 includes radio buttons for the player to select personal number entry 34 or computerized picking 36. A next button 38 selectively proceeds with the game ticket purchasing.

FIG. 2C illustrates the mobile communications device 20 displaying a series of game numbers 40 for selection by the player for a game ticket purchase. The display 24 includes instructions 42 to pick the first set of play numbers. The display includes the game indicia 22 and the winning potential 28. A next button proceeds with game ticket purchasing.

FIG. 2D illustrates a second selection screen for the particular game. A purchase button 46 proceeds with a purchase of the game ticket.

FIG. 3 illustrates the mobile communications device 20 displaying information from a telecommunications link to a commercial account and transaction payment service. The service interacts between the player and the lottery game provider. The player authorizes the service to transfer funds from an account of the player to an account of the lottery game provider. The display screen includes payment details generally 50 including authorization information 52, the particular lottery retailer information or payee 54, the name of the game 56 for which the lottery game ticket is purchased, the type of currency 58, and the purchase amount 60. Player account information such as balance 62 is displayed. A statement of activity 64 is displayed. A purchase button 66 authorizes the transaction.

FIG. 4 illustrates the mobile communications device 20 displaying an electronic random draw game ticket 68 purchased by the player and the transaction authorized by operation of the purchase button 66 shown in FIG. 3. The electronic game ticket 68 includes the indicia 22 of the particular game for which the ticket was purchased. The game ticket 68 includes the date and time of purchase generally 70. The selected numbers are printed in a game selection field generally 72. The drawing date 74 is displayed. The game ticket 68 includes the purchase price 76. A bar code 78 contains coded information about the ticket 68 including a game ticket identifier so that the game ticket purchased by the player can be traced and authenticated. The display functions as an electronic receipt for the purchase by the player.

The apparatus of the present invention is used for remote purchase of a random draw game ticket by a player local to a lottery ticket retailer as shown in FIG. 1. The player, using the pumps in the pumping area 12 for refueling a vehicle, may also initiate a random draw game ticket purchase. The player uses the mobile communications device 20 that is configured with an application for remote purchase of a random draw game ticket at a site local to the retailer game ticket terminal 16. The mobile communications device 20 initiates a communication link to the lottery terminal. The purchase application receives information about games available for purchase from the lottery. With a reference to FIG. 2A, the mobile communications device 20 displays the available games and indicia 22 on the display 24. The player, using the touchscreen display 24, selects one of the games 22 for game ticket purchase.

With a reference to FIG. 2B, the display 24 shows the selected game with its indicia 22 and winning potential 28. The player uses the date selector 30 to select the drawing date for the game ticket. The player selects the number of plays using the selection button 32. The player can enter specific numbers by selecting the radio button 34 or allow the computerized picking of numbers 36. The next button 38 is pressed to proceed with purchase of the game ticket.

In the event that the player selects self-pick numbers 34, FIG. 2C illustrates a display screen for selecting a first set of play numbers according to game instructions 42. The potential numbers from which selections can be made are shown in the series of numbers field 40. The touchscreen capability of the display 24 is used to select the appropriate number of numbers from the field 40. In the illustrated embodiment, a one touch selects the number and a second touch deselects it. The next button 44 proceeds with the purchase of the game ticket.

In the particular illustrated embodiment, a second set of numbers is selected for the particular game as depicted in FIG. 2D. Similarly, the player is instructed 42 to pick a second set of numbers from the field 40 for the game indicated by the indicia 22. A purchase button proceeds with the purchase of the game ticket.

In the event that the player had chosen two or more number of plays using the selector 32 shown in FIG. 2B, additional number of selection screens illustrated in FIGS. 2C and 2D would have been presented for each of the additional number of plays for the game ticket.

Upon selection of the game ticket, the application accesses a link to a commercial payment and transaction service. On such service is PAYPAL service. The application displays purchase authorization including the balance 62 in the player's account and the instructions “send money” 64. The payment details 50 are displayed including the authorization 52, payee 54, game 56 for which the game ticket is purchased, currency 58, and the amount of the purchase 60. The purchase button 66 authorizes the transfer of the funds from the player's account to the account of the lottery ticket provider.

With reference to FIG. 4, upon completion of the purchase transaction, the lottery terminal 16 transmits an electronic lottery game ticket generally 68 shown on the display 24 of the mobile communications device 20. The electronic random draw game ticket 68 can be saved to a memory device associated with the mobile communication device 20. The electronic game ticket 68 includes the indicia 22 of the particular game, the date of purchase 70, the game numbers 72, and the drawing date 74. The purchase value of the game ticket 68 is displayed 76 as well as a bar code 78.

The information about the game ticket is recorded by the lottery terminal and communicated to a central database of the lottery game provider for game-tracking activities.

In addition, the communications between the mobile communications device 20, the lottery terminal 16, and the commercial transaction and payment service are recorded and maintained as a log in a memory device of the lottery terminal 16. The log of remote purchase transactions are communicated to the central database of the lottery ticket provider for validation, verification and authentication purposes.

As noted above, the foregoing provides as an exemplary embodiment an apparatus and method for a lottery game player at the gas pump filling his vehicle with gasoline remote from the lottery terminal inside the gas supply and convenience store while completing a sales transaction involved in purchasing a lottery ticket from the lottery terminal local to that convenience store. Other retail stores may gainfully use the apparatus and method for remote yet local sales transactions for other non-lottery products or services, such as purchase of gift cards, tickets redeemable for goods or services, or products that may be picked up from a purchased product service counter at the store or delivered to an address specified by the buyer.

Generally, in another aspect the present invention is directed to:
apparatus and method for temporarily connecting an enabled mobile device with a products or services point-of-sale terminal system using short range wireless communications protocol;
apparatus and method by which the mobile communications device uses a mobile software application to generate a unique encrypted key;
apparatus and method by which the encrypted key is used to create a secure connection between the mobile communications device and the point-of-sale system;
apparatus and method by which the point-of-sale system causes a display of the products or services available for purchase on the mobile communications device;
apparatus and method by which the consumer user interface selections are stored and returned back to the point-of-sale system to log the purchase transaction;
apparatus and method by which the monetary transaction effecting payment for the purchase of the products or services is made using a commercial account and transaction payment service for transferring funds from the buyer to the products or services seller;
apparatus and method by which a unique ticket serial number barcode associated with the purchase of products or services is displayable on the display screen of the mobile communication device to create a paperless validation alternative for the retailer in redemption or exchange for the purchased products or services.

More particularly, the apparatus for completing a purchase transaction local to a retailer location but remote from a cashier therefor, comprises a short range wireless transceiver connected to a point-of-sale terminal for establishing a temporary connection with a mobile communications device of a buyer through a wireless communications protocol. The mobile communications device is configured to display at least one indicia of an available product or service offered for sale by the terminal, each available product or service having a discrete indicia, with selection means for selecting one of the available product or service which is to be purchased. An access link connects to a payment transfer system that communicates with an account of the buyer and an account of the seller for transferring funds from the account of the buyer to the account of the seller to pay for the selected one of the products or services purchased by the buyer. An electronic ticket representative of the purchase of the selected one of the products or services transfers from the point-of-sale terminal to the mobile communications device.

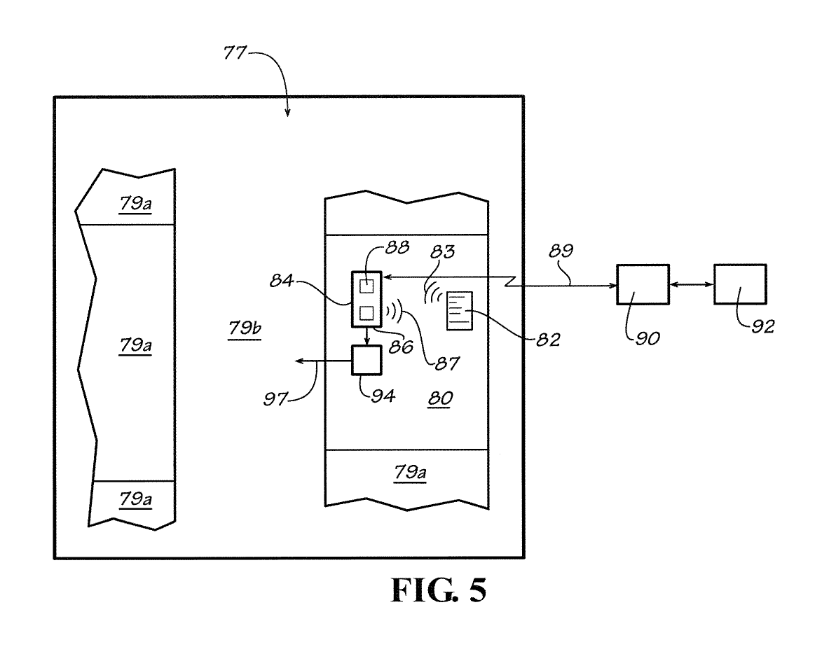

In that regard, FIG. 5 schematically illustrates a portion of a shopping center or mall 77 having stores generally 79a and a common walk-way 79b visited by a plurality of buyers carrying mobile communications devices 82 capable of communicating signals 83. A retail store 80 is equipped with a product or services sales terminal 84. The sales terminal 84 is a microprocessor computer device having a wireless broadcast device 86 configured for short range communication of a signal (denoted as 87) to the mobile communication devices 82 carried by buyers local to the retail store 80 remote from the sales terminal. The sales terminal 84 may also include a network communication device 88 that communicates 89 to a computer center 90 for the retailer, which computer center maintains a database 92 of buyers and sales transactions (encrypted key associated with or identifying the particular buyer, purchases of products or services, payments on account, and delivery of the products or services to the buyer). The store 80 includes a customer service station 94 at which products purchased by the buyer through the remote sales terminal 84 may be received by the buyer before departing 97 the local store.

The terminal 84 is configured with a computer software program instructions, that when executed, causes the broadcast device 86 to send 87 an availability signal that may be received by the mobile communications device 82, such as a “hot-spot” of an Internet access point. The mobile communications device 82 alerts the buyer to the signal. The buyer may select to cause the mobile communications device 82 to respond, or not. If the buyer responds, the software executing by the terminal 84 communicates 87 a list of products or services available for purchase by the buyer. The buyer then interacts with the sales terminal 84 by scrolling through the list and may select one or more products or services for purchase. This is similar to the lottery game player reviewing the list of lottery games and selecting to purchase a game ticket, as discussed above. Upon selecting one or more products or services by the buyer, the computer instructions executing on the terminal 84 responds by obtaining payment information, such as a commercial payment exchange service or payment from an account of the buyer. The buyer may further specify delivery information (to an address or for in-store pickup at the pickup station 94 before departure 97 while by-passing the conventional cashier stand. The sales transaction information communicates 89 to the retailer central computer system 90 and the customer accounting database 92 is updated. The terminal 84 communicates an electronic ticket or receipt to the mobile communications device 82. The electronic ticket includes information about the purchase of the products or services, for example, the transaction date, a transaction identification code, the product or service purchased, the account from which payment for the purchase is to be made, and other information conventional to a sales receipt.

A buyer may select having the product delivered (and provide a delivery address), or may select having the purchased product available for buyer pick-up at the customer service station 94. Upon presentation of the electronic ticket, the retailer provides the product for carry-out by the buyer.

It is to be appreciated that a business conducting sales transactions in accordance with the invention may select and implement a desired level of security, including the encrypted key generated with an application serial number associated with the software installed on the buyer's mobile communication device 82 and the UDID of the mobile communications device. For example, a buyer seeking to utilize the wireless remote purchase system while local to the store may register for such service including creating a secured key for identification and authentication of the buyer.

Another application of the apparatus and method is gainfully used in sales of items by entities having commissioned sellers, for example purchases of show, event, concert tickets or the like from ticket sellers. Often grocery stores or other shops have show ticket terminals that connect to the ticket selling entity. Patrons of ticket selling services would no longer wait in line to purchase tickets, but may use the mobile communications device to connect temporarily to the ticket seller terminal at the local grocery or other store. The electronic receipt of purchases of concert or event tickets would appear on the mobile communications device and include an identifying bar code. Customers present their mobile communication device displaying the electronic receipt at the event to use the tickets for access to the event.

The terminal 84 in the illustrated embodiment is a microprocessor apparatus configured with a wireless transmitter for communicating with mobile communication devices 20 within the range of the broadcast signal from the transmitter. By way of example, and not limitation, the terminal 84 may be a NETTOP computer device or equivalent that includes an 802.11N wireless NIC card configured for transmitting the signals of availability, the product or services information, and the electronic receipt. It is contemplated that terminal 84 after initialization and installation may operate without requiring a display or keyboard.

In an alternate embodiment, the mobile communications device 82 may have an executing software application that actively listens or receives broadcast signals from terminals 84, and upon receipt of such signal, alerts the buyer with a sound, vibration or other alerting message. In yet another alternate embodiment, the store applies a QR code to a sign in a product display or to the product container and positions the terminal locally in the store. The buyer may observe the product and have interest in making a purchase. The buyer scans the QR code using an imaging device of the mobile communications device 82. The QR code being interpreted by an application operating on the mobile communications device 82, causes the device 82 to initiate communications with the remote terminal 84 local to the buyer passing through a store. The communications between the terminal 84 and the mobile communications device 82 are as described above.

The foregoing specification accordingly describes the present invention that provides an apparatus and method that creates short-range communications between mobile communications devices of remote buyers and a goods or services sales terminal in order to complete a purchase transaction while the buyer is within a local range of the terminal. In one exemplary embodiment, the apparatus and method creates the remote short-range communications connection between the mobile communications device of the player of lottery games and the lottery ticket terminal in order to complete a lottery ticket purchase transaction while the player is within the local range of the terminal. Yet another exemplary embodiment facilitates purchase of goods or services by a buyer local to a sales facility or store remote from a cashier's station. It is to be understood, however, that numerous changes and variations may be made in the construction of the remote yet local purchase transaction apparatus and method within the spirit and scope of the present invention and that modifications and changes may be made therein without departing from the scope thereof as set forth in the appended claims.

What is claimed is:

1. A method for completing a lottery ticket purchase transaction local to a lottery ticket retailer location but remote from a lottery ticket cashier, comprising:
establishing a temporary connection between a mobile communications device of a player and a lottery point-of-sale terminal through short range wireless communications protocol;
displaying on a display screen of the mobile communications device at least one indicia of an available lottery game, each lottery game available having a discrete indicia;
selecting a lottery game for which a game ticket is to be purchased;
accessing a payment transfer system to transfer funds from an account of the player to the account of the lottery provider to purchase the game ticket; and
transferring to the mobile communications device an electronic lottery game ticket.

2. The method for completing a lottery ticket purchase transaction as recited in claim 1, further comprising encrypting the communications between the mobile communications device and the lottery point-of-sale terminal.

3. The method for completing a lottery ticket purchase transaction as recited in claim 1, further comprising encrypting the communications between the mobile communications device and the payment transfer system.

4. The method for completing a lottery ticket purchase transaction as recited in claim 1, further comprising storing as a running log the sequence and content of the communications between the mobile communications device, the lottery point-of-sale terminal, and the payment transfer system, and transferring the stored log to the lottery system upon completion of the purchase of the lottery game ticket.

5. The method for completing a lottery ticket purchase transaction as recited in claim 1, further comprising the step of creating a key for authenticating communication between the terminal and the mobile communications device.

6. An apparatus for completing a lottery ticket purchase transaction local to a lottery ticket retailer location but remote from a lottery ticket cashier, comprising:
a short range wireless transceiver connected to a lottery point-of-sale terminal for establishing a temporary connection with a mobile communications device of a player through a wireless communications protocol;
the mobile communications device configured to display at least one indicia of an available lottery game, each lottery game available having a discrete indicia;
selection means for selecting a lottery game for which a game ticket is to be purchased;
an access link to a payment transfer system that communicates with an account of the player and an account of the lottery provider for transferring funds from the account of the player to the account of the lottery provider to pay for the game ticket purchased by the player; and
an electronic lottery game ticket transferred from the point-of-sale terminal to the mobile communications device.

7. The apparatus for completing a lottery ticket purchase transaction as recited in claim 6, further comprising means for encrypting the communications between the mobile communications device and the lottery point-of-sale terminal.

8. The apparatus for completing a lottery ticket purchase transaction as recited in claim 6, further comprising means for encrypting the communications between the mobile communications device and the payment transfer system.

9. The apparatus for completing a lottery ticket purchase transaction as recited in claim 6, further comprising a memory device that stores a running log of the sequence and content of the communications between the mobile communications device, the lottery point-of-sale terminal, and the payment transfer system.

10. The apparatus for completing a lottery ticket purchase transaction as recited in claim 9, further comprising means for transferring the stored log to a central memory device of the lottery system upon completion of the purchase of the lottery game ticket.

11. The apparatus for completing a lottery ticket purchase transaction as recited in claim 6, further comprising a key for authenticating communication between the terminal and the mobile communications device.

12. A method for completing a purchase transaction local to a retailer location but remote from a cashier therefor, comprising the steps of:
(a) establishing a temporary connection between a mobile communications device of a buyer and a point-of-sale terminal through a short range wireless communications protocol;
(b) displaying on a display screen of the mobile communications device at least one indicia of an available product or service offered for selective purchase through the terminal by the buyer, each available product or service having a discrete indicia;
(c) selecting one of the available products or services which is to be purchased;
(d) accessing a payment transfer system to transfer funds from an account of the buyer to the account of the seller to purchase the selected one of available products or services; and
(e) transferring to the mobile communications device an electronic ticket representative of the purchase of the selected one of the available products or services.

13. The method for completing a purchase transaction as recited in claim 12, further comprising encrypting the communications between the mobile communications device and the point-of-sale terminal.

14. The method for completing a purchase transaction as recited in claim 12, further comprising encrypting the communications between the mobile communications device and the payment transfer system.

15. The method for completing a purchase transaction as recited in claim 12, further comprising storing as a running log the sequence and content of the communications between the mobile communications device, the point-of-sale terminal, and the payment transfer system, and transferring the stored log to a sales tracking database upon completion of the purchase of the selected one of the products or services.

16. The method for completing a ticket purchase transaction as recited in claim 12, further comprising the step of creating a key for authenticating communication between the terminal and the mobile communications device.

17. An apparatus for completing a purchase transaction local to a retailer location but remote from a cashier therefor, comprising:
a short range wireless transceiver connected to a point-of-sale terminal for establishing a temporary connection with a mobile communications device of a buyer through a wireless communications protocol;
the mobile communications device configured to display at least one indicia of an available product or service offered for sale by the terminal, each available product or service having a discrete indicia;
selection means for selecting one of the available product or service which is to be purchased;
an access link to a payment transfer system that communicates with an account of the buyer and an account of the seller for transferring funds from the account of the buyer to the account of the seller to pay for the selected one of the products or services purchased by the buyer; and
an electronic ticket representative of the purchase of the selected one of the products or services transferred from the point-of-sale terminal to the mobile communications device.

18. The apparatus for completing a purchase transaction as recited in claim 17, further comprising means for encrypting the communications between the mobile communications device and the point-of-sale terminal.

19. The apparatus for completing a purchase transaction as recited in claim 17, further comprising means for encrypting the communications between the mobile communications device and the payment transfer system.

20. The apparatus for completing a purchase transaction as recited in claim 17, further comprising a memory device that stores a running log of the sequence and content of the communications between the mobile communications device, the point-of-sale terminal, and the payment transfer system.

21. The apparatus for completing a purchase transaction as recited in claim 20, further comprising means for transferring the stored log to a central memory device of a seller's system upon completion of the purchase of the selected one of the products or services.

22. The apparatus for completing a purchase transaction as recited in claim 17, further comprising a key for authenticating communication between the terminal and the mobile communications device.
